(19) United States
(12) Patent Application Publication
(10) Pub. No.: US 2021/0199516 A1
(43) Pub. Date: Jul. 1, 2021

(54) Temperature Sensor Calibration

(71) Applicant: Medisim USA, Holly Springs, NC (US)

(72) Inventors: Moshe Yarden, Neve Ilan (IL); Vladmir Gorovetz, Neve Ilan (IL)

(73) Assignee: Medisim USA, Holly Springs, NC (US)

(21) Appl. No.: 17/270,159

(22) PCT Filed: Sep. 5, 2018
(86) PCT No.: PCT/US2018/049508

§ 371 Date: Feb. 22, 2021

(51) Int. Cl. G01K 15/00; G01K 1/02; G01K 7/22

(52) U.S. Cl. CPC G01K 15/005; G01K 7/22; G01K 1/02

(57) ABSTRACT

A calibrated temperature sensor (400) including a thermistor (410) having a non-linear resistance-temperature response, at least one parallel resistor (422) connected in parallel with the thermistor, optionally a second parallel resistor (420) connected in parallel with the thermistor (410) and in series with the first parallel resistor (422), and a serial resistor (424) serially connected to each of the thermistor (410) and parallel resistor(s) (420, 422). The parallel resistor(s) is adapted to linearize the resistance-temperature response (511) and to flatten the resistance-temperature response to a predetermined slope (521). The serial resistor is adapted to increase the resistance-temperature response to a predetermined bias (531).

### FIELD OF USE

The present application is directed to a calibrated temperature sensor including a thermistor, and methods of performing the calibration.

### BACKGROUND

A resistor is an electrical component that opposes electrical charge. A thermistor is a resistor whose resistance changes based on temperature. An NTC (negative temperature coefficient) thermistor is a thermistor whose resistance is negatively affected by a change in temperature; thus as the temperature around the thermistor increases, the resistance of the thermistor decreases, and as the temperature decreases the resistance of the thermistor increases. Conversely, a PTC (positive temperature coefficient) thermistor is a thermistor whose resistance is positively affected by a change in temperature; thus as the temperature around the thermistor increases, the resistance of the thermistor increases, and as the temperature decreases the resistance of the thermistor decreases. The thermistor's change in resistance in response to changes in temperature (the resistance-temperature response) is commonly characterized using a graphical plot of resistance vs. temperature (a resistance-temperature curve).

A thermistor is often manufactured according to two parameters. The first parameter of the thermistor is its nominal resistance (R₀) at a predetermined nominal temperature (To). Ordinarily, the nominal temperature is chosen to be about 25° C. The second parameter is the beta value (β) of the thermistor, which is the thermistor's sensitivity to changes in temperature, and is typically around 3500 to 4000 K. The relationship between resistance and temperature for a particular thermistor may be expressed in terms of these two parameters using the following equation:

$${R}_{T H} = {R}_{0} {exp}^{β ( \frac{1}{T} - \frac{1}{{T}_{0}} )} \qquad ( 1 )$$

whereby R_{TH} is the resistance of the thermistor at any given temperature T, and whereby β, T₀ and T are measured in units of Kelvin.

As is evident from equation (1), the relationship between resistance and temperature for a given thermistor is non-linear, making the plot of resistance vs. temperature a curved line. In order to simplify the resistance-temperature curve, it is generally known to substantially linearize the thermistor response. This is ordinarily accomplished by placing a resistor in parallel with the thermistor.

FIG. 1 provides a circuit diagram of an example temperature sensor circuit 100, in which a resistor 120 is positioned in parallel with a thermistor 110. A current may be applied to the circuit 100 from a probe (not shown), and the resulting voltage may be measured. The probe may be connected to the current applied, and the voltage measured at terminal 140. The voltage at terminal 140 is dependent on the resistance of the thermistor 110, and the resistance of the thermistor 100 is dependent on the measured temperature (T). Thus, temperature T may be determined based on the voltage measurement at terminal 140.

FIG. 2 provides a block diagram of a system 200 for temperature readout from a temperature sensor 100. The temperature sensor 100 is connected to a digital control unit 210. The digital control unit 210 is configured to convert the analog output of the temperature sensor 100 to a digital signal indicative of the measured temperature, process the digital signal, and finally provide the digital signal to a display 220 for readout. In certain applications, the display may be configured to receive a value indicative of resistance that is related to temperature according to an industry standard, such as YSI-400 or YSI-700. In such an application, the digital control unit is embedded into the display unit, such as a vital signs monitor, and may be configured to convert the voltage or current signal that are related to the sensor resistance into resistance value (received from the temperature sensor 100) to a temperature value according to the industry standard, and then provide the converted digital signal to the display 220 for temperature readout.

During production, there can be inconsistency in the β and R₀ parameters from one thermistor to the next. Additionally, when a parallel resistor is mounted for linearization, there may be deviations of the slope and the bias of the resistance-temperature curve, over a given linear range on that curve. One way to deal with this inconsistency is to test the β and R₀ parameters for each thermistor, and to test the linearized slope and bias parameters for each thermistor, and to use only the thermistors that meet or fall within an acceptable range of the desired parameters, and to discard the remaining thermistors. However, this solution is wasteful, and thus costly. Therefore, there is still a need in the art to calibrate the thermistors, such that the resistance of each thermistor is the same for a given temperature across a given range of temperatures, within an acceptable tolerance.

### BRIEF SUMMARY

The present disclosure provides an ordered method by which a thermistor may be calibrated to a nominal curve, e.g. a curve which provides same resistance readout for a given temperature within acceptable tolerance for multiple thermistors, by the addition of parallel and serial resistors. The nominal curve is a curve that provides a common resistance for a given temperature for multiple thermistors within an acceptable tolerance, and it is selected based on the known range of parameters of the thermistors.

One aspect of the disclosure provides for.

### BRIEF DESCRIPTION OF THE DRAWINGS

FIG. 1 is a prior art circuit diagram of a prior art temperature sensor.

FIG. 2 is a prior art block diagram of a prior art temperature sensing and readout system.

FIG. 3 is a flow diagram of a method for calibrating a temperature sensor in accordance with the present disclosure.

FIGS. 4A, 4B, 4C and 4D are circuit diagrams of a temperature sensor being calibrated using the method of FIG. 3.

FIGS. 5A, 5B, 5C and 5D are graphical resistance-temperature plots of a thermistor being calibrated using the method of FIG. 3.

FIGS. 6A and 6B are top and bottom views of an array of temperature sensors in accordance with the present disclosure.

FIG. 7 is a block diagram of a temperature sensing and readout system in accordance with the present disclosure.

### DETAILED DESCRIPTION

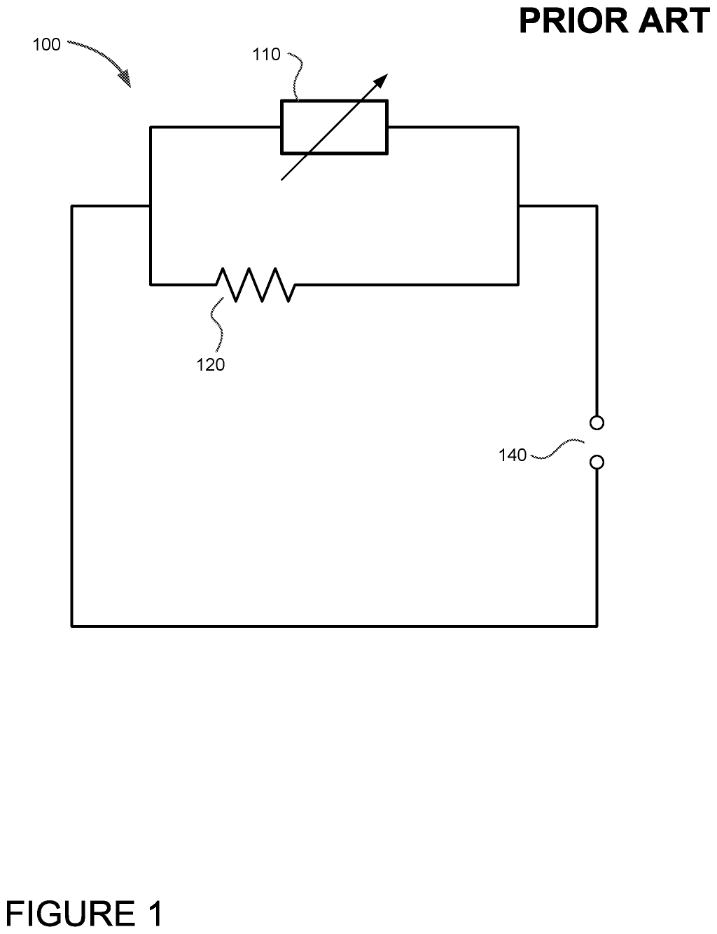

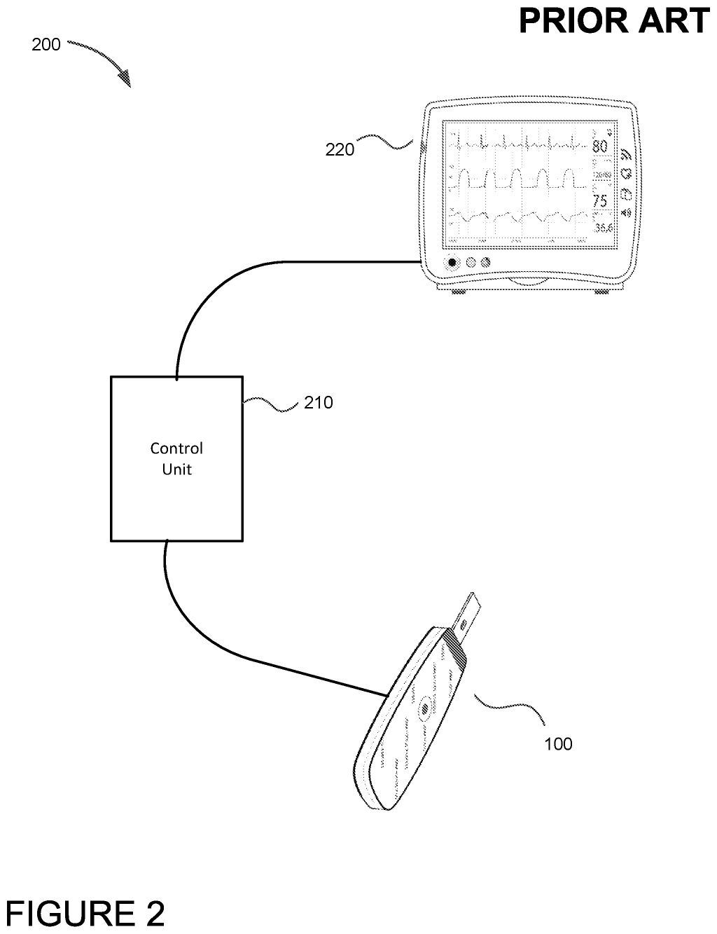

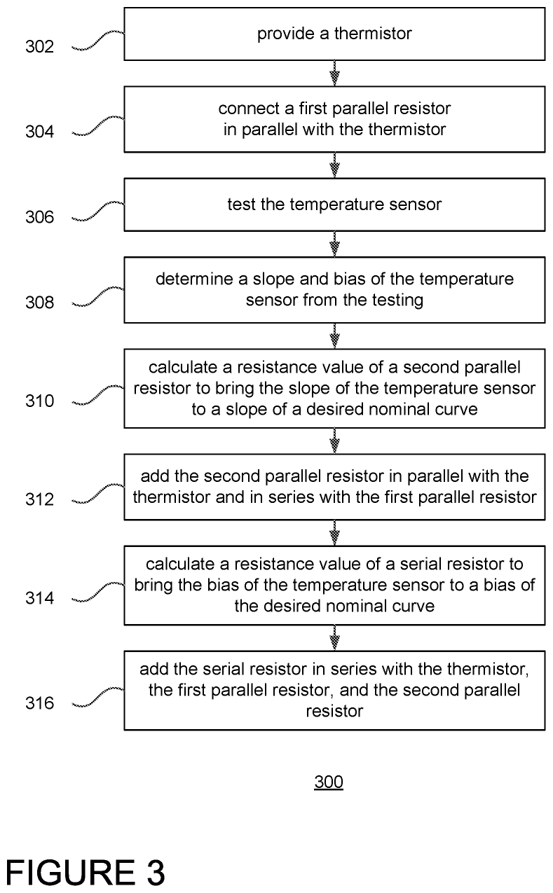

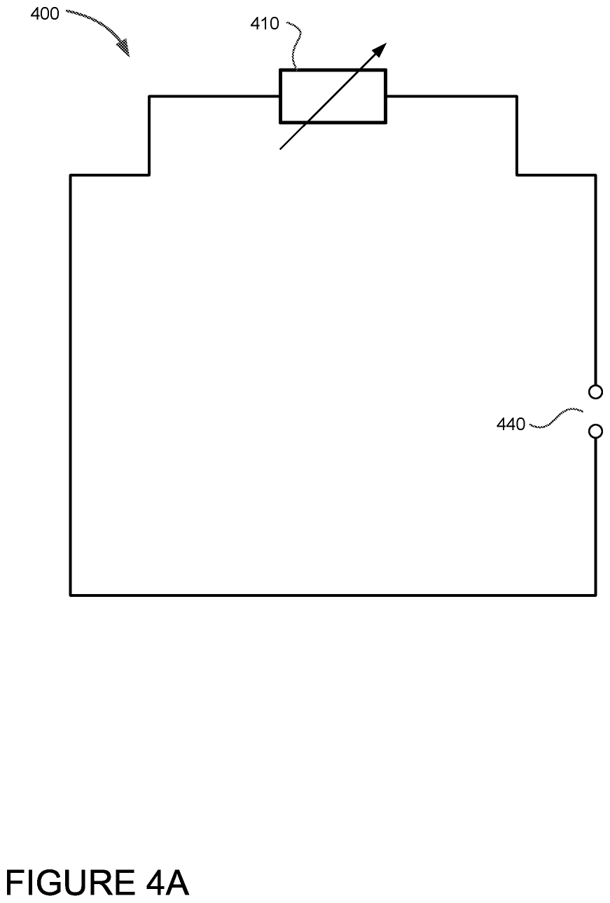

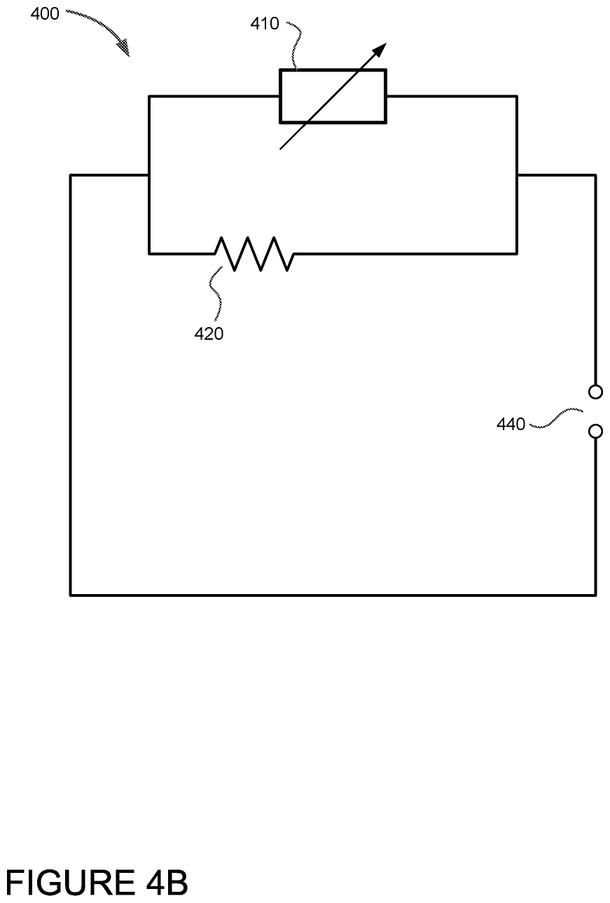

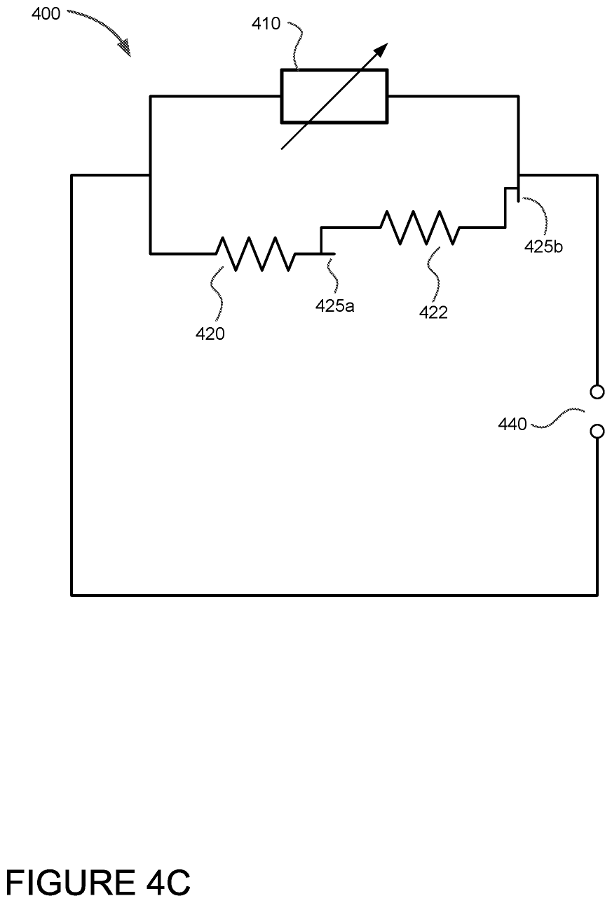

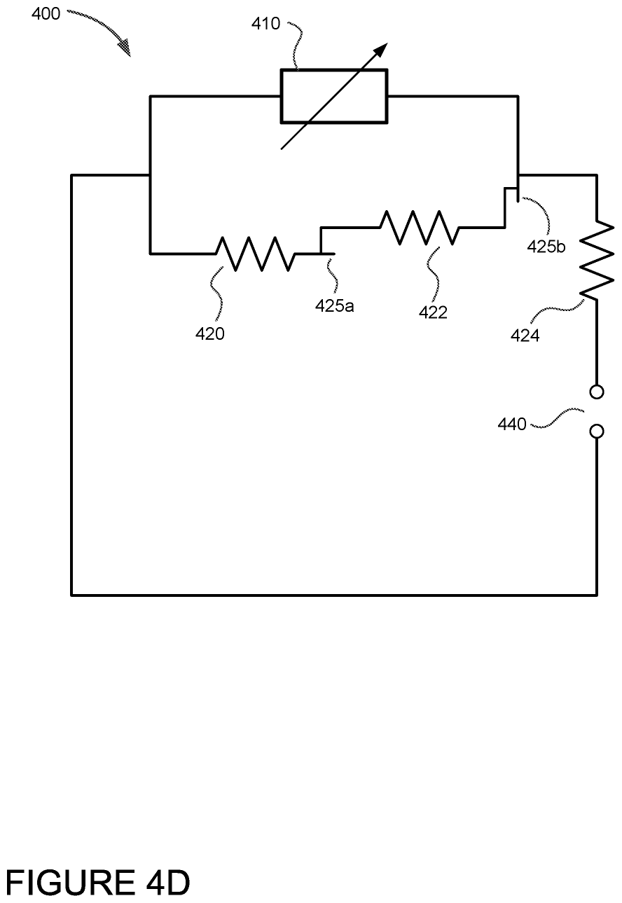

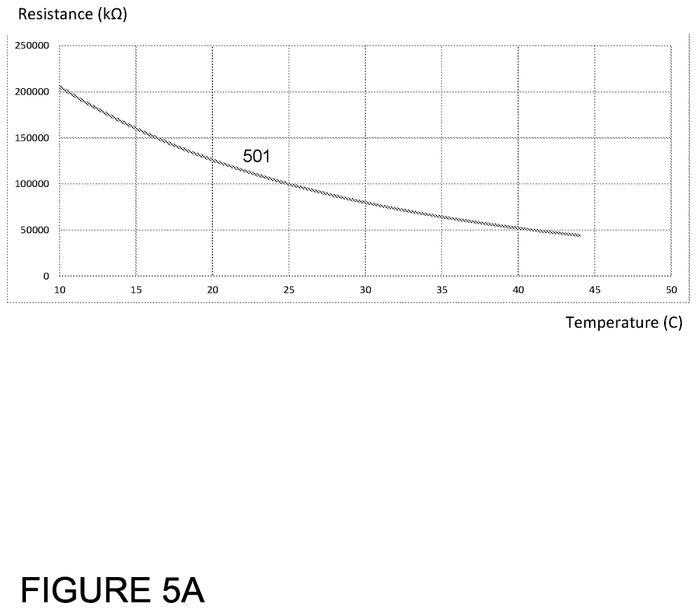

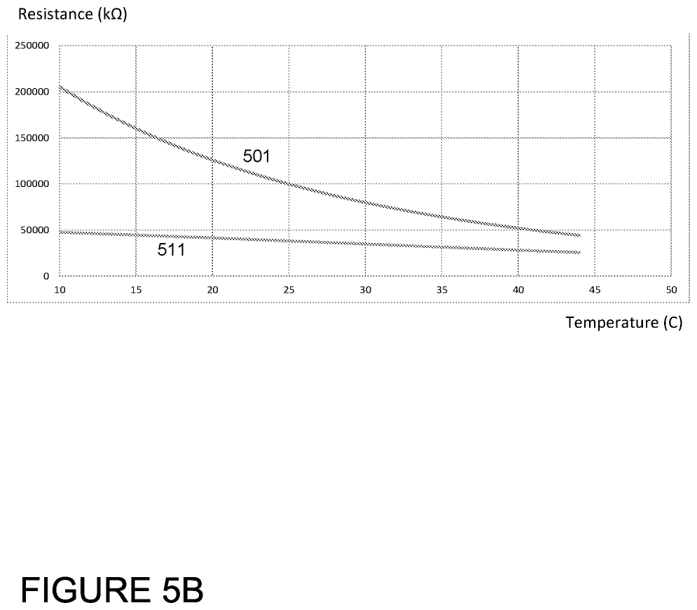

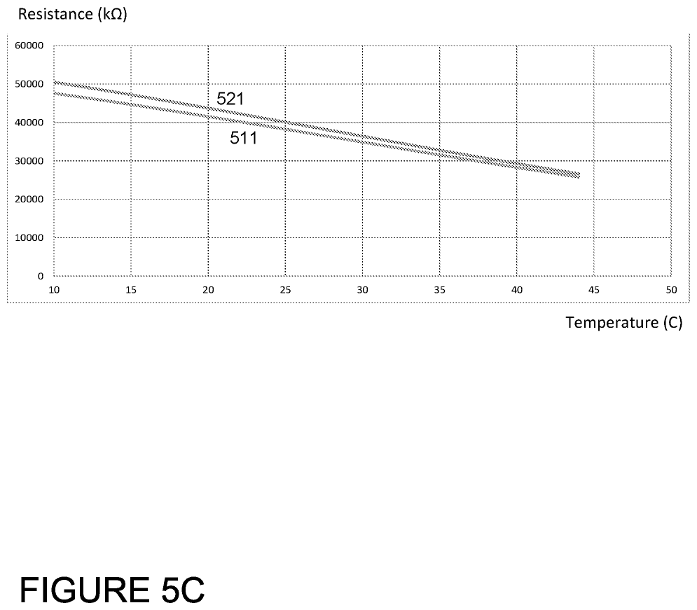

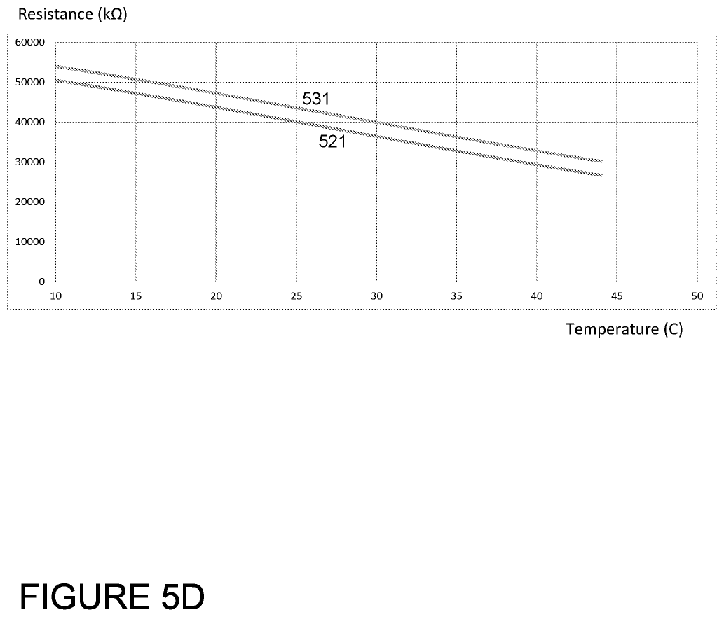

FIG. 3 is a flow diagram of an example calibration method 300 according to the present disclosure. For purposes of simplicity, the method takes as a starting point a temperature sensor comparable to the temperature sensor 100 of FIG. 1. Reference is further made throughout the description of the method to FIGS. 4A-4D and FIGS. 5A-5D, which illustrate the changes made to the temperature sensor, in terms of a circuit diagram (FIGS. 4A-4D) and in terms of a resistance-temperature curve (FIGS. 5A-5D). A single circuit diagram is shown in FIGS. 4A-4D, and a single correspondence resistance-temperature curve is shown in each of FIGS. 5A-5D, respectively. However, due to the variance in β and R₀ parameters among thermistors, it should be understood that while every temperature sensor from a given batch of thermistors may be represented by the same circuit diagram, not every temperature sensor can be represented by the same resistance-temperature curve, since each thermistor may have different parameters. After the temperature sensors are properly calibrated the resistance-temperature responses of the temperature sensors may be the same. Additionally, the resistance-temperature curves shown in the example of FIGS. 5A-5D are for an NTC thermistor. However, in other examples, the same principles of the present disclosure may be applied to calibrate a batch of PTC thermistors.

The method 300 begins at block 302 with a thermistor being provided. FIG. 4A is a circuit diagram of a temperature sensor 400 including only the thermistor 410. The thermistor is placed on a circuit having a terminal 440, comparable to the component described earlier in connection with FIG. 1. FIG. 5A demonstrates a resistance-temperature curve 501 for such a temperature sensor. As noted above, due to variance in β and R₀ parameters among the thermistors in various temperature sensors, the resistance-temperature curves among a batch of temperature sensors are not identical.

At block 304, a first parallel resistor is connected in parallel with the thermistor. FIG. 4B illustrates the addition of the first parallel resistor 420 to the temperature sensor 400. In some instances, the resistance of the first parallel resistor 420 may be chosen to be about the same for each temperature sensor. However, as will be explained later, due to deviations of the resistance values of the resistors, different resistances may be selected for and different resistors mounted to each temperature sensor, as the differences will be normalized during a later calibration step. The nominal value of the first parallel thermistor 420 may be selected according to an expected temperature range where the sensor will be used to measure temperature, since linearity of the curve is most important in the expected temperature range.

For any given temperature, the total resistance R_{TOT} of the thermistor 410 (having resistance R_{TH}) and the first parallel resistor 420 (having resistance R_{P}) may be expressed using the following formula:

$${R}_{T O T} = {( \frac{1}{{R}_{T H}} + \frac{1}{{R}_{P}} )}^{- 1} \qquad ( 2 )$$

At block 306, the temperature sensor is tested. Testing may involve placing the temperature sensor in a temperature-controlled environment, such as a water bath, and measuring the effective resistance of the temperature sensor. Such testing may be conducted multiple times with each test being conducted at a different controlled temperature, in order to collect multiple resistance-temperature data points. A resistance-temperature curve may then be extrapolated from the collected data points using any extrapolation method known in the art, for example linear interpolation or least squares method.

Because the testing is performed after the addition of the parallel resistor 420, fewer test points are needed to extrapolate the resistance-temperature curve from the collected data points. This is because the resistance-temperature curve is expected to be linear over the expected temperature range, meaning as few as two data points may be needed to conduct sufficient testing. Nonetheless, in some instances, it may be preferable to collect more than two data points (e.g., three data points, five data points, ten data points, fifteen data points) in order to ensure accurate determination of the resistance-temperature curve. In one embodiment, the temperature sensor is passed through a series of four water baths, each set to a different controlled temperature, and data points are collected for each of the four controlled temperatures.

FIG. 5B demonstrates the linearized resistance-temperature curve 511 for the temperature sensor. It should be noted that even after linearization of the resistance-temperature curves, the linearized curves of different temperature sensors still have different slopes and different biases. This is due to the variance in β and R₀ parameters among the thermistors being used, as well as due to any variance in the parallel resistors used to linearize the thermistor response.

Due to the variability of the thermistor's parameters, as well as variability in the first parallel resistor, the resistance-temperature curve 511 may have a different slope and bias than the desired nominal curve of the temperature sensor. At block 308, each of a slope and a bias of the linearized temperature sensor may be determined based on the data points obtained from the testing.

Using knowledge of the determined slope (block 308) and knowledge of the desired nominal curve of the temperature sensor 400, at block 310 a resistance value for a second parallel resistor may be determined to bring the slope of the temperature sensor to the slope of the desired nominal curve. In other words, for a given second parallel resistor added to the temperature sensor 400, there will be a predictable change in the slope of the temperature sensor's resistance-temperature curve. Therefore, it can be determined what value resistance must be added in series with the first parallel resistor 420 (and in parallel to the thermistor 410) in order for the temperature sensor 400 to reach a the slope of the desired nominal curve.

At block 312, once the resistance value for the second parallel resistor has been determined, a second parallel resistor having the correct resistance value may be added to the temperature sensor 400, in parallel with the thermistor 410 and in series with the first parallel resistor 420. FIG. 4C illustrates an example arrangement including the second parallel resistor 422, in which a connecting wire 450 between the first parallel resistor 420 and the terminal 440 is severed. In some instances, this may leave severed ends 425a and 425b of the original wire. The second parallel resistor 422 is then inserted between the first parallel resistor 420 and the terminal 440, and new connecting wiring 452 is provided to facilitate the connection. In other example arrangements, the second parallel resistor may be inserted elsewhere, such as connected to the other side of the first parallel resistor 420, as long as it remains in parallel with the thermistor 410.

For any given temperature, the total resistance R_{TOT} of the thermistor 410 (having resistance R_{TH}) first parallel resistor 420 (having resistance R_{P1}) and second parallel resistor 422 (having resistance R_{P2}) may now be expressed using the following formula:

$${R}_{T O T} = {( \frac{1}{{R}_{T H}} + \frac{1}{{R}_{P 1} + {R}_{P 2}} )}^{- 1} \qquad ( 3 )$$

The resistance of the second parallel resistor is chosen to bring the resistance-temperature curve of the temperature circuit to a nominal slope. One method to derive the second parallel value is to use an iterative procedure in which an initial resistance value is guessed and a new slope is computed based on the initial guess. This step may be repeated by guessing different resistance values based on the computed slopes until a desired nominal curve is yielded. The resulting resistance-temperature curve 521 is shown in FIG. 5C. At this stage, each of the resistance-temperature curves for a given batch of calibrated temperature sensors will now share a common, nominal slope, although the curves may still be differently biased.

The second parallel resistor 422 may be chosen to have a resistance that is less than the first parallel resistor 420. For instance, if the first parallel resistor 420 is chosen to have a resistance on the order of thousands or tens of thousands of ohms, the second parallel resistor 422 may be chose to have a resistance on the order of tens to hundreds of ohms. In this sense, the relatively small second parallel resistor may be thought of as correcting for differences between the first parallel resistor's actual resistance and its nominal value. For example, if the first parallel resistor in each temperature sensor has a nominal resistance of 4.7 kΩ with a margin of error of ±5%, then each resistor may have an actual resistance of between about 4.46 kΩ and about 4.94 kΩ. Then, by using a second parallel resistor of between 0Ω and 470Ω (e.g., less than or equal to the margin of error of the first parallel resistor), the differences in actual resistance among first resistors can be corrected by the smaller second resistors. This avoids the need for providing overly precise resistance values without adversely affecting the overall precision of the final calibrated temperature sensors. Thus, by splitting the parallel resistance into two resistors, it is possible to calibrate out the deviations of the first parallel resistor which has a relatively high resistance by compensating for these deviations with the second parallel resistor which has a relatively low resistance.

Similarly, using knowledge of the determined bias (block 308) and knowledge of the desired nominal curve of the temperature sensor 400, at block 314 a resistance value for a serial resistor may be determined to bring the bias of the temperature sensor to the bias of the desired nominal curve. In other words, for a given serial resistor added to the temperature sensor 400, there will be a predictable change in the bias of the temperature sensor's resistance-temperature curve. Therefore, it can be determined what value resistance must be added in series with the thermistor 410, first parallel resistor 420 and second parallel resistor 424 in order for the temperature sensor 400 to reach the bias of the desired nominal curve.

At block 316, once the resistance value for the serial resistor has been determined, a serial resistor having the correct resistance value may be added to the temperature sensor 400, in series with each of the thermistor 410, first parallel resistor 420, and second parallel resistor 422. FIG. 4D illustrates an example of the serial resistor 424 being added between the other components and the terminal 440. Alternatively, the serial resistor may be added on the other side of the thermistor 410 and parallel resistors 422, 424.

For any given temperature, the total resistance R_{TOT} of the thermistor 410 (having resistance R_{TH}), first parallel resistor 420 (having resistance R_{P1}), second parallel resistor 422 (having resistance R_{P2}) and serial resistor 424 (having resistance R_{S}) may now be expressed using the following formula:

$${R}_{T O T} = {( \frac{1}{{R}_{T H}} + \frac{1}{{R}_{P 1} + {R}_{P 2}} )}^{- 1} + {R}_{S} \qquad ( 4 )$$

The resistance of the serial resistor is chosen to bring the resistance-temperature curve of the temperature circuit to a common bias. The resulting resistance-temperature curve 531 is shown in FIG. 5D. At this stage, the temperature sensors are now fully calibrated, and as such share both a common slope and a common bias. In this sense, the calibrated temperature sensors are roughly identical to one another in that they provide the same resistance (or a resistance within the same tolerable range of resistances) over a given range of temperatures. In the case of a YSI-400 standard temperature sensor, the temperature sensor may have a sensitivity of about 45 ohm/° C., which means that for a temperature sensor to have an accuracy of about ±0.1° C., the temperature sensor must be accurate within about 4.5 ohms for a given temperature in the expected temperature range.

The result of this method 300 is a plurality of calibrated temperature sensors that share common resistance-temperature curves, in terms of both slope and bias. This means that the temperature sensors are calibrated over a substantial range of temperatures, since the resistance of the sensor is predictable along the entire or at a large portion of the resistance-temperature curve. Additionally, the method achieves this calibration without having to discard any thermistors for having different 13 and R₀ parameters.

The slope and bias of the final curve of the temperature sensors may be values chosen in advance based on the known variances in β and R₀ parameters for the thermistors being used. Knowing the variances in β and R₀ parameters means that the range of slopes and biases for the thermistors is also known. It is also known that increasing the resistance value of a resistor placed in parallel with the thermistor will result in a steepening of the slope of the resistance-temperature curve, and that increasing the resistance value of a resistor placed in series with the thermistor will result in raising the bias of the curve. Therefore, if a maximum slope among the range of slopes is chosen as the slope for the final curve, then it will be possible to bring all temperature sensors to the final slope by adding a resistor in parallel—although the value of the parallel resistor will vary from sensor to sensor. Likewise, if a maximum bias from the range is chosen as the bias for the final curve, then it will be possible to bring all temperature sensors to the final slope by adding a resistor in series—although the value of the serial resistor will vary from sensor to sensor.

Stated another way, if one chooses the final curve to have the maximum slope (or more) and maximum bias (or more) from among the known ranges for a batch of thermistors, it would enable all of the temperature sensors to be calibrated with none of the sensors needing to be discarded. It should be noted that the final curve of each temperature sensor may have a variance within an acceptable tolerance, such as ±0.1° C. for clinical temperature sensing applications.

In one example, a batch of thermistors may have values of β around 4250 with a tolerance of about 3% or less, and of R₀ around 100 kΩ with a tolerance of about ±5% or less. In such a case, a parallel resistor having a value of between about 40 kΩ and about 80 kΩ, and preferably between 62 kΩ and 67 kΩ, may be provided to linearize the thermistor. The second parallel resistor of about 3 kΩ to about 10 kΩ, and preferably about 5 kΩ, may then be chosen to correct the slope of the sensor to a nominal slope, and a serial resistor of about 1 kΩ to about 5 kΩ, and preferably about 3.5 kΩ, may be provided to correct the bias of the sensor to a nominal bias. It should be understood that the chosen values of the second parallel resistor and serial resistor for each sensor will necessarily differ in order to correct the different resistance-temperature responses yielded by each sensor during the testing stage, and that this variance is understood in the approximate resistance values specified above.

The method 300 of FIG. 3 is advantageous in that in can easily be automated. It is generally known in the relevant art that the active functions of adding resistors to the temperature sensor, transferring the temperature sensor between water baths, and measuring the temperature sensors can be included in an automated assembly line protocol. Additionally, these automated activities can be combined with or otherwise guided by automated processing steps, such as functions for extrapolating resistance-temperature curves, or calculating an appropriate resistance value to be added to the temperature sensor circuit. Thus, those skilled in the art would readily recognize that method 300 may be an automated process.

The example process of FIG. 3 demonstrates how a linearized thermistor may be tested and calibrated. In other instances, it may be possible to calibrate the thermistor before a parallel resistor is provided to linearize the thermistor response. In such instances, block 304 of FIG. 3 may be omitted, and the non-linear resistance-temperature response of the thermistor may be tested at block 306 in the manner described above. During the testing, several data points (e.g., 10 data points, 15 data points) may be collected. A high-order calibration, such as a third order calibration, may then be applied to the data points, and a best-fit curve may be identified through the high-order calibration. The high-order calibration may involve determining a resistance value “R” that results in the thermistor fitting a nominal high-order curve over a range of temperatures using error minimizing techniques (e.g., least squares method). For instance, in the case of a third order calibration, the nominal curve may be represented by the following expression:

T(R)=a₃R³+a₂R²+a₁R+a₀, (5)

in which values a₀, a₁, a₂ and a₃ are determined during the testing stage based on the measured resistances across the range of tested temperatures, and value R is the total resistance value that causes the function T(R) (which T is the temperature corresponding to a given resistance value R) to most closely match the desired nominal curve. Using the total resistance value R, parallel and serial resistor values may then be selected in order to bring the total resistance of the temperature sensor to value R.

Additionally, the calibration method may be conducted for all temperature sensors at the same time. For instance, the temperatures sensors may be printed on a single array, and then passed through a testing apparatus and production line at the same time.

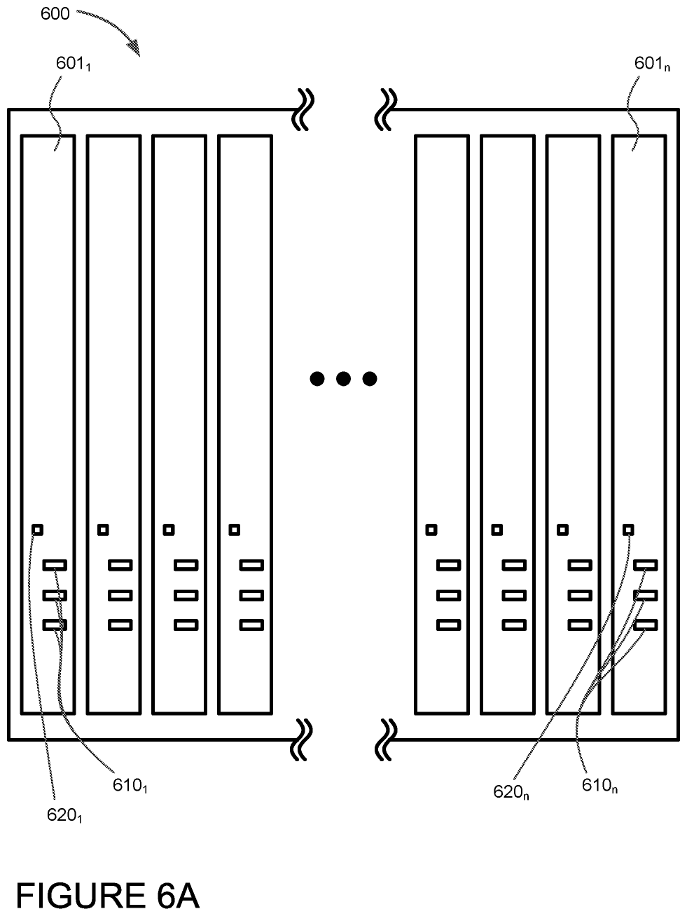

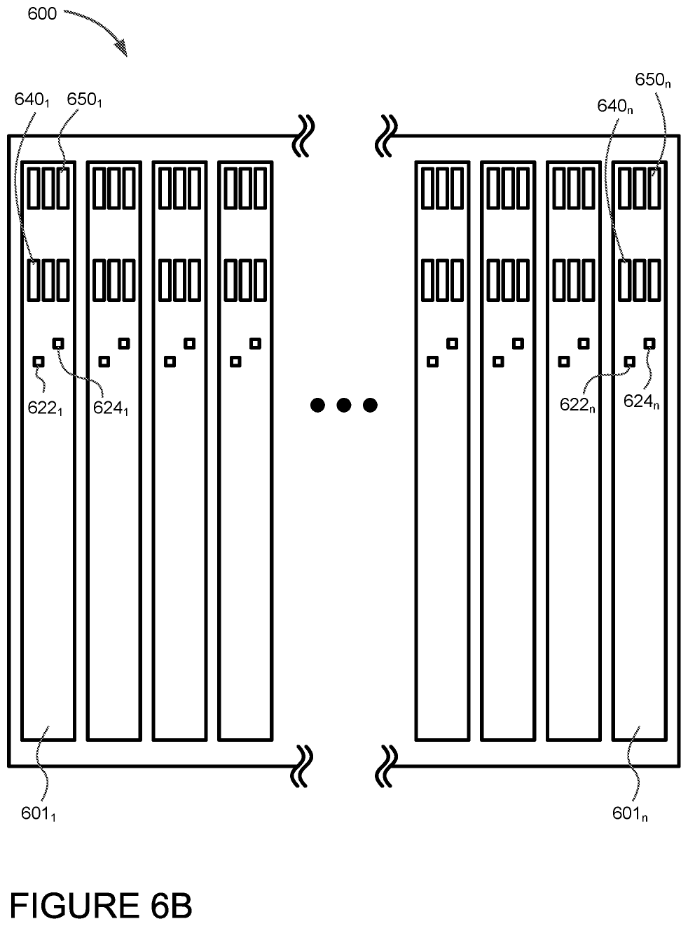

FIGS. 6A and 6B illustrate an example array 600 having several temperature sensors 601₁-601ₙ printed side by side on a substrate of the array 600. FIGS. 6A and 6B are opposing surfaces or sides of the array 600, whereby FIG. 6A may be referred to as a top side and FIG. 6B as a bottom side, for vice versa. The array 600 in FIG. 6 demonstrates an example possible arrangement of the components of the temperature sensors 601₁-601ₙ, including the thermistors 610₁-610ₙ, first parallel resistors 620₁-620ₙ, second parallel resistors 622₁-622ₙ serial resistors 624₁-624ₙ, and terminals 640₁-640ₙ. The entire array 600 can be placed into a water bath at the same time. The array 600 may be sealed with a nylon or similar material sheath to eliminate water penetration. Simultaneous testing of sensors may cut down testing time for a batch of thermistors 610₁-610ₙ, which in turn minimizes the risk of temperature fluctuations from one test to the next. This ensures that the calibration method is completed efficiently and with reduced error. Once calibration is complete and the temperature sensors 601₁-601ₙ are ready for use, they may be separated from one another, such as by cutting the spaces in the substrate between the sensors 601₁-601ₙ.

In the example of FIGS. 6A-6B, the thermistors 610₁-610ₙ and the first parallel resistors 620₁-620ₙ are separated from the second parallel resistors 622₁-622ₙ and the serial resistors 624₁-624ₙ by being positioned on opposite surfaces of the substrate. This separation makes it possible to use surface-mounting technology (SMT) in order to assemble the second parallel resistors and the serial resistors, as they are positioned on a bare side of the substrate which is assembled only after measuring in water baths the resistance and determining the appropriate value of second parallel and serial resistor for each sensor.

In the example of FIG. 6A, it should be noted that three thermistors are shown. Those skilled in the art will recognize that a temperature sensor may include multiple thermistors in order to measure multiple points at the same time and provide a more accurate overall measurement. Nonetheless, for purposes of the present application, all three thermistors may be treated as a single thermistor, meaning all three thermistors are linearized using a single parallel resistor, and then calibrated using a second parallel resistor and a single serial resistor.

In some applications, a temperature sensor may include multiple sets of thermistors, each responsible for conducting a different measurement. In such cases, each set of thermistors may be connected to its own first parallel resistor, second parallel resistor and serial resistor. Nonetheless, an array of temperature sensors may be configured to accommodate the separate sets of thermistors and accompanying circuitry.

Additionally, in some applications, each temperature sensor 601₁-601ₙ may begin with two terminals included. A testing terminal 650₁-650ₙ may be positioned at an end of the sensor, and may complete a circuit with only the thermistors 610₁-610ₙ, first parallel resistors 620₁-620ₙ. The testing terminals 650₁-650ₙ may be used at block 306 to test the resistance-temperature characteristics of the respective temperature sensors 601₁-601ₙ. Then, after the testing, the testing terminals 650₁-650ₙ may be cut from the array, leaving only terminals 640₁-640ₙ. Each of the thermistors 610₁-610ₙ, the first parallel resistors 620₁-620ₙ, the second parallel resistors 622₁-622ₙ and the serial resistors 624₁-624ₙ are included in the circuit with the terminals 640₁-640ₙ, in order to provide calibrated measurements in the finished temperature product.

The above examples describe calibration methods and array configurations that rely on the addition of new resistors. However, in other examples, a calibration method may involve modifying the resistance values of the originally provided resistors. One way to modify a resistor's value is by laser cutting or trimming. In such an instance, the temperature sensor curve of the temperature sensors may first be evaluated, for instance by the testing in block 306. Then, at block 308, instead of adding a second parallel resistor, the resistance value of the first parallel resistor of each temperature sensor may be modified using laser cutting in order to bring each of the resistance-temperature curves of the tested temperature sensors to a common slope. Serial resistors may then be added at block 310 in order to make the bias of each resistance-temperature curve uniform.

In yet a further alternative embodiment, a serial resistor having an arbitrary resistance may be provided for each temperature sensor before the testing in block 306 (testing the temperature sensor). Then, at block 310, instead of adding a serial resistor, laser cuts may be used to modify the resistance of the previously provided serial resistors based on the results on the testing in block 306.

One advantage of laser cutting is that it allows for fewer components to be used in the production of the temperature sensor. Instead of the final temperature sensor including three resistors, the same result can be achieved using only two resistors. However, laser cutting can be expensive, and sometimes can be imprecise. Additionally, care should be taken to distance the thermistor from the resistors, since heat from the laser cutting can cause thermal shock to the thermistor and alter the thermistor's parameters.

The above examples describe a calibration method that eliminates waste of thermistors by choosing slope and bias values at or beyond the maximum or minimum of the expected range for a batch of thermistors. However, in other examples, the final values may be selected such that they are close to but not at the maximum or minimum of the expected range of values. In this regard, waste may be significantly reduced although not completely eliminated.

Alternatively, the final slope and bias values may be chosen to conform to an industry standard. For example, the slope and bias may be chosen to match nominal values for a resistance-temperature curve in accordance with the YSI-400 standard for thermistors. Alternatively, the values may be selected to conform to the YSI-700 standard. In other example, other standards may be used. The parallel and serial resistors are then chosen to conform the thermistor's behavior to the resistance-temperature curve of the selected industry standard.

If the resistance-temperature curve for the temperature sensor is chosen in accordance with an industry standard, then the output of the temperature sensor will also meet that industry standard. Standardizing the temperature sensor in this manner is advantageous, since it means that the temperature sensor can easily be interfaced with standardized equipment.

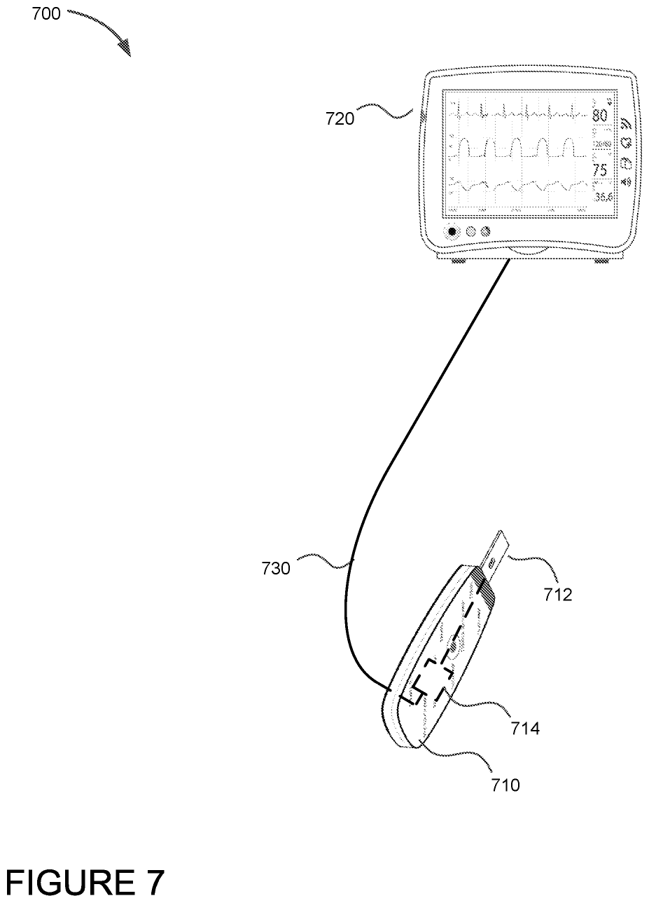

For example, FIG. 7 shows a block diagram of a standardized system 700 for temperature sensing and readout. The system 700 includes a temperature sensor 710 connected to a display 720 via a cable 730. The temperature sensor 710 includes a thermistor 712 and resistor network 714 including resistors in series with the thermistor, in parallel with the thermistor, or both, in accordance with the principles of the present disclosure. The resistor network 714 is specially designed to bring the resistance-temperature curve of the temperature sensor in conformance with an industry standard.

The display 720 is configured to receive and readout a resistance value according to the same industry standard as the temperature sensor. Since the output of the temperature sensor 710 is directly indicative of the total resistance of thermistor 712 and resistor network 714, the display 720 can be directly connected to the temperature sensor 710 without the need for additional interfacing equipment, such as digital control unit. Furthermore, in the case of a display that receives an analog input, the interfacing can be purely analog, with no need for the temperature sensor output to be converted to a digital signal, processed by a digital control unit, and then converted back into an analog signal. Ultimately, conforming the temperature sensor to the industry standard of the monitor significantly simplifies the temperature sensing and readout system 700, in turn reducing its cost and maintenance requirements.

The examples in the present disclosure consider temperatures appropriate for a thermistor used in a hospital thermometer application, such as the Temple Touch Pro™ made by Medisim Ltd which is configured to connect to a vital signs monitor. However, those skilled in the art would readily appreciate that the same calibration method may be applied to any of numerous thermistor applications.

Although the disclosure herein has been described with reference to particular embodiments, it is to be understood that these embodiments are merely illustrative of the principles and applications of the present disclosure. It is therefore to be understood that numerous modifications may be made to the illustrative embodiments and that other arrangements may be devised without departing from the spirit and scope of the present disclosure as defined by the appended claims.

1. A calibrated temperature sensor comprising:
a thermistor having a non-linear resistance-temperature response;
at least one resistor connected in parallel with the thermistor, the resistor adapted to adjust the resistance-temperature response to a predetermined slope; and
a serial resistor serially connected to each of the thermistor, and the parallel resistor, the serial resistor adapted to increase the resistance-temperature response to a predetermined bias.

2. The calibrated temperature sensor of claim 1, wherein the at least one resistor connected in parallel with the thermistor comprises two resistors, wherein a resistance of one of the resistors is less than a resistance of the other resistor.

3. The calibrated temperature sensor of claim 1, wherein the predetermined slope is a nominal slope selected based on a range of one or more parameters of a plurality of thermistors.

4. The calibrated temperature sensor of claim 1, wherein the predetermined bias is a maximum bias selected based on the range of one or more parameters of the plurality of thermistors.

5. The calibrated temperature sensor of claim 2, wherein the one or more parameters includes at least one of a nominal resistance (R₀) and a beta value (β) of the plurality of thermistors.

6. The calibrated temperature sensor of claim 1, wherein the predetermined slope and the predetermined bias are selected based on an industry-standard resistance-temperature curve.

7. The calibrated temperature sensor of claim 5, wherein the industry-standard resistance-temperature curve is a YSI-400 temperature curve.

8. The calibrated temperature sensor of claim 1, further comprising:
a first terminal configured to receive a probe for measuring a total resistance of the thermistor and the at least one parallel resistor.

9. The calibrated temperature sensor of claim 1, further comprising:
a second terminal configured to receive a probe for measuring a total resistance of the thermistor, the at least one parallel resistor, and the serial resistor.

10. An array, comprising a plurality of calibrated temperature sensors, each calibrated temperature sensor including a thermistor, at least one parallel resistor, and a serial resistor as recited in claim 1, the plurality of calibrated temperature sensors being arranged side by side on a substrate.

11. A system for temperature sensing and readout, comprising:
a calibrated temperature sensor as recited in claim 1; and
a display configured to receive an output signal from the temperature sensor, and to display a temperature measured by the temperature sensor.

12. The system of claim 11, wherein the output signal from the temperature sensor is an analog signal indicative of a total resistance of the thermistor, the at least one parallel resistor, and the serial resistor, and wherein the display is configured to receive and interpret analog signals according to a predetermined industry standard.

13. A method for calibrating a temperature sensor comprising:
testing the resistance-temperature response of the temperature sensor at a plurality of controlled temperatures, the temperature sensor having a thermistor with a non-linear resistance-temperature response;
connecting at least one parallel resistor in parallel with the thermistor to linearize the resistance-temperature response and to adjust the resistance-temperature response to a predetermined slope; and
connecting a serial resistor in series with each of the thermistor and the at least one parallel resistor, to increase the resistance-temperature response to a predetermined bias.

14. The method of claim 13, wherein a first of the at least one parallel resistors is connected in parallel to the thermistor before testing the resistance-temperature response of the temperature sensor, and a second of the at least one parallel resistors is connected in parallel to the thermistor after testing the resistance-temperature response of the temperature sensor, the first of the at least one parallel resistors linearizing the resistance-temperature response, and the second of the at least one parallel resistors adjust the resistance-temperature response to the predetermined slope.

15. The method of claim 13, further comprising:
using the method for each of a plurality of temperature sensors, and
testing each of the temperature sensors at the same time;
wherein, for each given temperature sensor, resistance values of at least one parallel resistor to adjust the resistance-temperature response to a predetermined slope and the serial resistor are chosen independent of the other temperature sensors based on one or more parameters of the thermistor of the given temperature sensor.

16. The method of claim 15, wherein the one or more parameters includes at least one of a nominal resistance (R₀) and a beta value (β) of the thermistor.

17. The method of claim 13, wherein the resistance value of the at least one parallel resistor to adjust the resistance-temperature response to a predetermined slope is selected such that the predetermined slope is a nominal slope selected based on a range of the one or more parameters among the plurality of thermistors.

18. The method of claim 13, wherein the resistance value of the serial resistor is selected such that the predetermined bias is a maximum bias selected based on a range of the one or more parameters among the plurality of thermistors.

19. The method of claim 14, further comprising:
severing a wire connection between the first of the at least one parallel resistors and a terminal of the temperature sensor after testing the resistance-temperature response of the temperature sensor at a plurality of controlled temperatures; and
forming a new wire connection between the first of at least one parallel resistors and a terminal of the temperature sensor, wherein the second of the at least one parallel resistors and the serial resistor are connected to the first of the at least one parallel resistors by the new wire connection.

20. The method of claim 19, wherein severing the wire connection involves disconnecting the first of the at least one parallel resistors from a testing terminal of the temperature sensor, and wherein forming the new wire connection involves connecting the first of the at least one parallel resistors to a second terminal of the temperature sensor.

21. The method of claim 13, wherein testing the resistance-temperature response of the temperature sensor at a plurality of controlled temperatures comprises:
successively placing the temperature sensor in a series of water baths, each water bath having a different controlled temperature;
for each water bath, measuring a total resistance of the temperature sensor at the controlled temperature of said water bath; and
extrapolating a resistance-temperature curve from the total resistance measurements.
